(19) United States
(12) Patent Application Publication
(10) Pub. No.: US 2021/0296875 A1
(43) Pub. Date: Sep. 23, 2021

(54) BAR-TYPE CABLE ORGANIZING APPARATUS ADAPTABLE TO CABLE VOLUME

(71) Applicant: Jeongsoo LEE, Bucheon-si (KR)

(72) Inventor: Jeongsoo LEE, Bucheon-si (KR)

(21) Appl. No.: 17/261,011

(22) PCT Filed: Jul. 17, 2019
(86) PCT No.: PCT/KR2019/008837

§ 371 Date: Jan. 16, 2021

(30) Foreign Application Priority Data
Jul. 18, 2018 (KR) 10-2018-0083588

(51) Int. Cl. H02G 3/32; B65H 75/28

(52) U.S. Cl. CPC H02G 3/32; B65H 2701/514; B65H 75/285

(57) ABSTRACT

The present invention relates to a cable organizing apparatus, specifically to an adaptable cable organizing apparatus comprising: a flexible main body which can be freely bent and unbent in accordance with the length and thickness of variety of cables, such as a power cord attached to electric and electronic devices; and a plurality of elastic holding parts, attached on the main body, facilitating the entry, winding and unwinding, and locking and unlocking of a cable. As such, the cable is circularly wound, not bent and folded, which protects the cable and provides an aesthetically pleasing outer appearance, and minimizes the volume of the wound cable.

### TECHNICAL FIELD

The present invention relates to a cable organizing apparatus, and specifically, to an adaptable cable organizing apparatus including: a flexible main body that is freely bent and unbent according to a length and a thickness of various cables including a power cord attached to electrical and electronic devices; and a plurality of holding parts coupled to a top surface of the main body, having an elastic recovery force, configured to facilitate entry and exit, winding and unwinding, and locking and unlocking of a cable. Accordingly, the cable is wound in a circular shape without being bent and folded, so that the cable is protected, an aesthetic appearance of the wound cable is improved, and a volume of the wound cable is minimized.

### BACKGROUND ART

There are numerous cables spread in a disorderly manner or entangled around us, such as power cables of electronic products such as a TV, a refrigerator, a computer, and a washing machine, various cables for internet, a telephone, a video, an audio, and the like, cables of various chargers, a mouse cable, a keyboard cable, a laptop computer power cable, power cables of various beauty products such as a hair dryer and a hair iron, cables of electrical and electronic products for kitchen, sports equipment power cables, power tool power cables, and a standing signboard power cable, so that it is necessary to organize these cables.

When the cables are not organized, an aesthetic appearance may be deteriorated, and there may be a functional failure such as occurrence of danger when the cable is damaged by a user stepping on or tripped over the cable, furniture or other objects pressing the cable, electric vehicles or other objects passing over the cable in the case of a business site, or other various surrounding environments, so that it is necessary to protect the cable while organizing the cable.

In addition, cables wound in an incorrect scheme may cause electrical safety problems or communication problems, so that it is necessary to wind the cables in a correct scheme.

For a more specific example, seasonal devices such as an electric heater, an air conditioner, or an electric pad are stored after their season of use, and used when the season of use returns. Since many periods of the year are non-use periods of the seasonal devices, organization, an organization scheme, and protection of power cables are very important in terms of an aesthetic appearance and electrical safety.

In the case of the electric pad, even during the season of use, a cord has to be separated from a power source to prevent a fire when a user wakes up in the morning, and reconnected to the power source at night. Since an installation place of the electric pad is a room floor, a living room floor, a bed, or the like, a power cable is directly connected to the electric pad or connected to the electric pad across the floor via a power strip from a wall outlet, so that the user may be tripped over the power cable or may step on the power cable. Accordingly, a negligent accident may occur, or the aesthetic appearance and the electrical safety may be deteriorated.

In addition, beauty devices such as a hair dryer, a hair iron, a skin massager, and a razor are repeatedly used for a while and left unattended. In this case, when the cables are not organized, the cables are always left in a complicated and twisted state, so that use of the beauty devices may be inconvenient, and the aesthetic appearance and the electrical safety may be deteriorated.

Further, for an electric iron, a glue gun, a soldering machine, a signboard, and an external hard disk drive in which a power cord has to be unplugged when not in use, cable organization, unwinding, and storage are important in terms of the aesthetic appearance and the electrical safety.

Similarly, it is important to organize cables of kitchen appliances such as an electric frying pan, a boiling pot, and a blender because a power cord is connected for a while only when in use and disconnected after use in many cases, it is important to organize cables of a small radio and a cassette player because the small radio and the cassette player are frequently moved indoors and outdoors, and it is necessary to organize cables of exercise equipment such as a treadmill installed in a homes, a sports center, or the like because the exercise equipment has very long cables that are easily left in a disorderly manner.

In addition, USB cables of various chargers such as a smartphone charger are frequently left in a disorderly manner during charging and after the charging, and the smartphone charger, a laptop computer power cable, and a mouse are often carried. Particularly, in the case of a laptop computer, when the laptop computer is carried, a considerably long power cable and a mouse have to be put in a bag, and operations of taking out cables, unwinding the cables for installation, and using the cables are repeatedly performed when transfer is finished, and when the laptop computer is in use, the long power cable and a mouse cable are obstructive and thus inconvenient, so that it is important to organize and unwind the cables upon opposite cases of carrying and using the laptop computer.

Further, power cables of a laptop computer, a monitor, and a set-top box, which are longer than cables of other electronic and electrical products and equipped with a power adapter or the like, are configured such that a thick alternating-current wire and a thin direct-current wire are connected to opposite sides of the adapter, respectively, so that there are difficulties in integrally organizing the power cables with cables of other electrical and electronic products. In addition, there are difficulties in integrally organizing a power cable of an air conditioner, which is regulated to be connected to only an outlet defined by law and generally installed in an independent place, with other cables.

Similarly, data cables such as an internet cable (LAN), a USB data cable, and a telephone line have a relatively thin thickness, have a long length, or are arranged in mutually different directions, so that there are difficulties in integrally organizing the data cables with power cables of electrical and electronic products.

In addition, in various industrial sites, it is necessary to organize or protect cables of a power tool, a soldering machine, an iron, and other various electrical and electronic equipment.

On the contrary, a refrigerator, a kimchi refrigerator, a washing machine, a water purifier, a microwave oven, a router, a modem, and the like are products that tend to be less mobile once they are placed in one place. In many cases, it is unnecessary to unwind or wind power cables or data cables of the above products after a single organizing operation, while the above products are located independently, so that there are difficulties in integrally organizing the cables of the above products with cables of other electrical and electronic products. When a redundant section of the cable that is longer than a distance from the above product to an outlet is not organized, the cable may be continuously left in a disorderly state, so that it is necessary to organize the cable. In addition, there may be a case where the cables of these electronic products are organized again due to moving, a repair work, location shifting, or the like.

On the contrary, TV peripherals such as a TV, a set-top box, and a sound bar, computer peripherals such as a computer, a monitor, a printer, and a scanner, and the like are products that tend to be less mobile once they are placed in one place. In many cases, it is unnecessary to unwind or wind cables of the above products after a single organizing operation, while there are a great number of cables related to the above products, so that it is necessary to integrally organize the cables. In addition, there may be a case where the cables of these electronic products are organized again due to moving, a repair work, location shifting, or the like.

Meanwhile, most power cords of electrical and electronic products used in Korea are generally rated for 250V and 10 A, and classified into a round cable type and a flat cable type, in which the flat cable type has a thickness that is thinner than a thickness of the round cable type. Power cords of electrical and electronic products used in countries such as the United States, which are rated for 125V and 10 A, have a thickness that is thinner than a thickness of the power cable for 250V and 10 A.

The USB data cable and a direct-current power cord section of a monitor, a laptop computer, or the like have a thickness that is much thinner than the thickness of the above power cord, and an earphone cable is one of the thinnest cables. Since the earphone cable is thin and flexible, it is easy to wind and unwind the earphone cable, and since the USB data cable is thicker and less flexible than the earphone cable and has a length of 1.8 m, it is difficult to wind and unwind the USB data cable as compared with the earphone cable. Accordingly, there may be a case where a USB data cable of a smartphone charger or the like is manufactured to have a short length of about 50 cm for portability.

However, when compared with the earphone cable or the USB data cable, cables used for power cords of electrical and electronic products are much thicker and less flexible, and have a length that is generally about 1.5 m and sometimes exceeds 2 m, so that it is difficult to organize the cables used for the power cords of the electrical and electronic products.

Korean Unexamined Patent Publication Nos. 10-2010-0033504 and 10-2006-0015965 disclose a cable organizing apparatus using a circular winding or unwinding scheme, in which the above cable organizing apparatus is for an earphone cable and a USB data cable with a short length, so that the organizing apparatus using the above scheme is not suitable for winding and unwinding a USB data cable having a general length of 1.8 m, and may not be used to the cables used for the power cords of the electrical and electronic products.

Above all, a cable that is the most difficult to be organized is a power cord standardized for 250V and 16 A, which is used for a power cord or an extension cord of a power strip. This cable has a thickness that is much thicker than the thickness of the power cord (250 V and 10 A) of the electrical and electronic products, which causes the cable to be less flexible, and has a length of about 1.5 m, which is often 3 m or 5 m, so that the cable may not be organized in an appropriate volume or less with a cable organizing apparatus using a circular or elliptical winding or unwinding scheme.

Documents of Related Art

Patent Documents

(Patent document 1) Korean Unexamined Patent Publication No. 10-2010-0033504

(Patent document 2) Korean Unexamined Patent Publication No. 10-2006-0015965

### DETAILED DESCRIPTION OF THE INVENTION

### Technical Problem

To solve the problems as described above, an object of the present invention is to provide an adaptable cable organizing apparatus including: a flexible main body that is freely bent and unbent according to a length and a thickness of various cables including a power cord attached to electrical and electronic devices; and a plurality of holding parts coupled to a top surface of the main body, having an elastic recovery force, configured to facilitate entry and exit, winding and unwinding, and locking and unlocking of a cable. Accordingly, the cable may be wound in a circular shape without being bent and folded, so that the cable may be protected, an aesthetic appearance of the wound cable may be improved, and a volume of the wound cable may be minimized.

### Technical Solution

To achieve the objects as described above, according to the present invention, a bar-type cable organizing apparatus adaptable to a cable volume includes:

a main body formed of a flexible material in a rectangular band shape; and one or a plurality of holding parts spaced apart from each other in a longitudinal direction on a top surface of the main body to accommodate a cable, and formed of an elastic material in a cylindrical ring shape with an incision at an upper end thereof, wherein the main body is pressed so as to be deformed into a curved shape, a circular shape, or a vortex shape, and the cable is wound and stored in the holding part located on an outer side of the main body.

In this case, the main body may have an elastic restoring force.

In addition, a metal bar formed of a soft material may be inserted into the main body so that the main body may maintain a shape corresponding to a deformed shape of the metal bar.

In addition, the main body may be provided on the top surface thereof with a coupling device coupled with the holding part to allow the holding part to rotate.

In addition, the main body may be provided on a bottom surface thereof with an adhesive device that is attachable to a wall surface, or a sticker on which an advertisement, a decoration, or an identification code is printed may be attached to the bottom surface of the main body.

In addition, the coupling device may include a hinge sill or a press-fit hole.

In addition, the main body may include: a fixed part having a hollow shape; and a variable part configured to slide in the longitudinal direction while being accommodated in the fixed part to allow a length of the main body to be varied.

In addition, the holding part may be provided at a lower end thereof with a hinge shaft coupled to the coupling device of the main body.

In addition, the holding part may be press-coupled to the coupling device of the main body or installed to have an angle fixed in multiple stages so as to maintain a changed state when the holding part is pressed to change the angle in order to fix the cable.

In addition, locking devices coupled to each other to prevent the cable from being separated may be provided on opposite sides of an upper end of the holding part, respectively.

In addition, a guide plate may extend horizontally from opposite ends of an upper end of the holding part to prevent the cable from being separated and to guide insertion of the cable.

In addition, the holding part may include an auxiliary locking device to prevent the cable from being separated.

In addition, the main body or the holding part may be mixed with a thermochromic pigment so as to be discolored and recognized by a user when the cable is overheated due to an overload or an electrical short.

### Advantageous Effects

According to the present invention configured as described above, the adaptable cable organizing apparatus includes: a flexible main body that is freely bent and unbent according to a length and a thickness of various cables including a power cord attached to electrical and electronic devices; and a plurality of holding parts coupled to a top surface of the main body, having an elastic recovery force, configured to facilitate entry and exit, winding and unwinding, and locking and unlocking of a cable. Accordingly, the cable can be wound in a circular shape without being bent and folded, so that the cable can be protected, the aesthetic appearance of the wound cable can be improved, and the volume of the wound cable can be minimized.

In addition, according to the present invention, the adaptable cable organizing apparatus can be adapted to cables having various thicknesses and lengths to wind or unwind the cables; cables having a thickness or a length exceeding an inner diameter volume of the holding part can be held; even when the cables having a volume that is less than the inner diameter volume of the holding part are wound, a winding state of the cables can be prevented from loosening only by an operation of laying the holding part; it is easy to rapidly wind or unwind the cables, which is convenient; it is easy to rapidly and frequently wind or unwind a required amount or an entire amount of the cables, which is more convenient; and cables for non-use electronic and electrical products including seasonal appliances such as an electric heater and a fan can be optimized for long-term storage.

Further, according to the present invention, the main body can be extended so as to be used as a cable tie for organizing a plurality of cables; a double-sided sticker, a magnet, a Velcro, or the like can be attached to the bottom surface of the main body so as to be attached to a wall surface, furniture, and the like; the main body can be bent so as to be used as a cable tie for organizing a plurality of cables at an angled place such as a corner; the holding part can be separated from the main body so that only the holding part can be used as an independent cable tie; the adaptable cable organizing apparatus is very compact with a lightweight and a small size, which is convenient to carry; while occupying a less space, ultra-compact cables such as an earphone cable, a charger cable, a USB data cable, and cables that are very thick or very long such as a power strip cable (250V, 16 A, and 1.5 m˜5 m), a telephone line, or an internet cable (5˜10 m) can be organized; the adaptable cable organizing apparatus can be attached to all cables through an integrated form with cables and an ultra-compact structure to facilitate carrying or storage, prevent loss, and improve an aesthetic appearance; and the adaptable cable organizing apparatus can be attached to electronic and electrical products, a power strip, a wall outlet, a charger, a laptop computer power adapter, and the like through an integrated design with the electronic and electrical products, the power strip, the wall outlet, the charger, the laptop computer power adapter, and the like, and an ultra-compact structure to facilitate storage or immediate use, prevent loss, and improve an aesthetic appearance.

In addition, according to the present invention, a length of the main body can be adjusted so that various cables can be organized; and a thermochromic pigment or the like, which has a color changed according to a temperature, are added to the main body or the holding part, or a discoloration sticker is attached to the main body or the holding part, so that when the cable is overheated due to an overload or an electrical short, the color is changed into a preset color, which can be recognized by users to prevent a fire, an electric shock, and the like or protect the cable.

### DESCRIPTION OF THE DRAWINGS

FIG. 1 is a perspective view showing a configuration of a bar-type cable organizing apparatus adaptable to a cable volume according to one embodiment of the present invention.

FIG. 2 is a perspective view showing a configuration of a bar-type cable organizing apparatus adaptable to a cable volume according to another embodiment of the present invention.

FIG. 3 is a perspective view showing a configuration of a bar-type cable organizing apparatus adaptable to a cable volume according to still another embodiment of the present invention.

FIG. 4 is a partial perspective view showing configurations of a coupling device and a holding part of the bar-type cable organizing apparatus adaptable to the cable volume according to the present invention.

FIG. 5 is a partial perspective view showing the configuration of the holding part of the bar-type cable organizing apparatus adaptable to the cable volume according to the present invention.

FIG. 6 is a partial perspective view showing a configuration of a guide plate of the bar-type cable organizing apparatus adaptable to the cable volume according to the present invention.

FIG. 7 is a partial perspective view showing a configuration of an auxiliary locking device of the bar-type cable organizing apparatus adaptable to the cable volume according to the present invention.

FIGS. 8 to 11 are operation views for describing states in which a cable is organized by using the bar-type cable organizing apparatus adaptable to the cable volume according to the present invention.

FIG. 12 is an operation view for describing a state in which a cable is organized by using the auxiliary locking device of the bar-type cable organizing apparatus adaptable to the cable volume according to the present invention.

FIG. 13 is an operation diagram for describing a state in which an advertisement of the bar-type cable organizing apparatus adaptable to the cable volume according to the present invention is exposed.

FIG. 14 is an operation diagram for describing a state in which the bar-type cable organizing apparatus adaptable to the cable volume according to the present invention is used as a cable tie.

### MODE FOR INVENTION

### [Best Mode]

Hereinafter, a configuration of a bar-type cable organizing apparatus adaptable to a cable volume according to the present invention will be described in detail with reference to the accompanying drawings.

In the following description of the present invention, detailed descriptions of the related known function or configuration may be omitted when they are determined to make the subject matter of the present invention rather unclear. In addition, terms that will be described below are terms defined in consideration of functions thereof in the present invention, which may vary according to the intention of a user or an operator, precedents, or the like. Therefore, the terms should be defined based on the contents throughout the present disclosure.

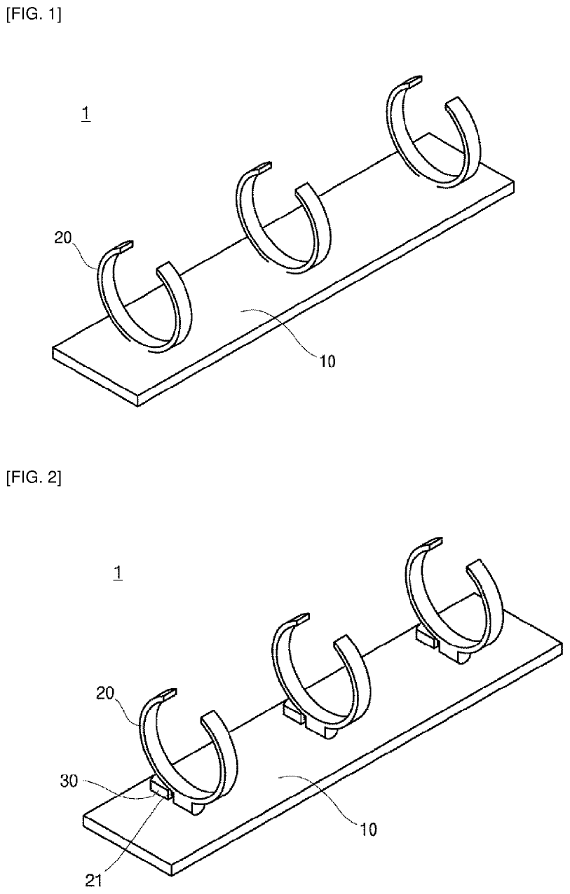

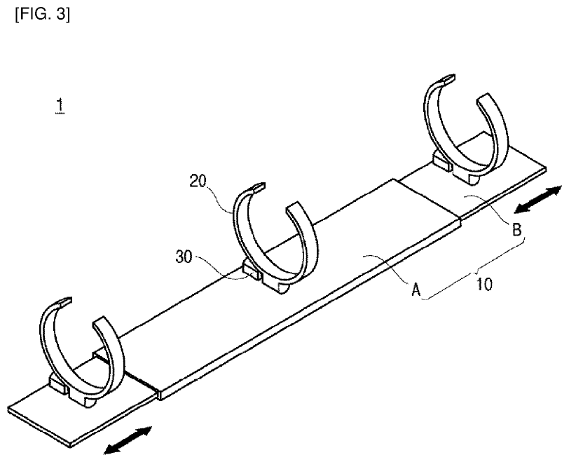

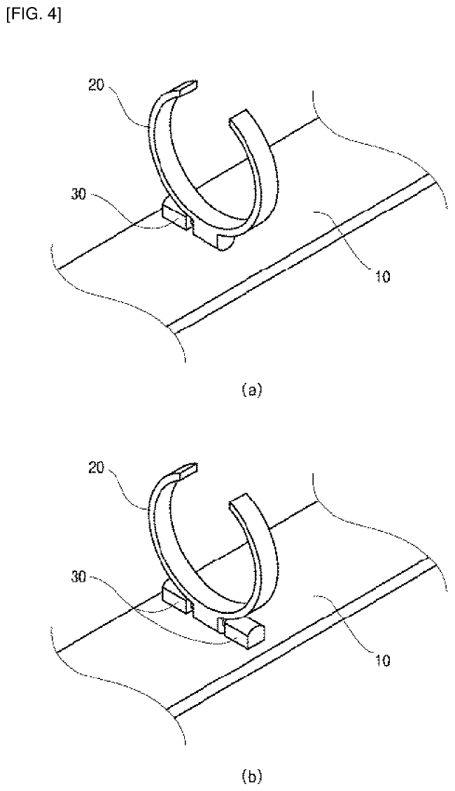

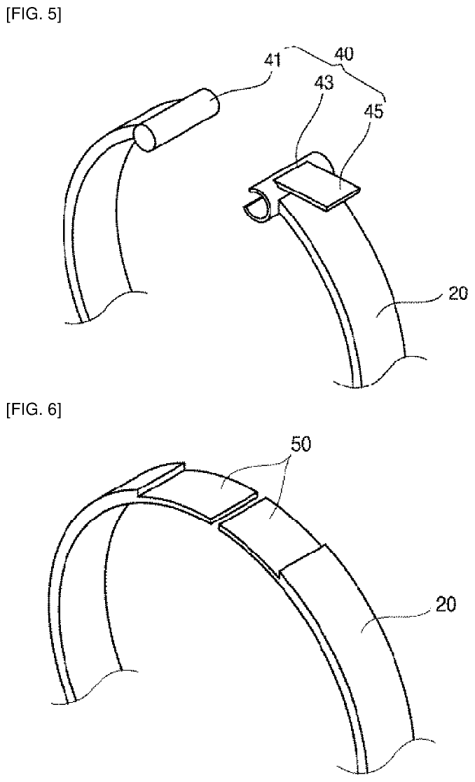

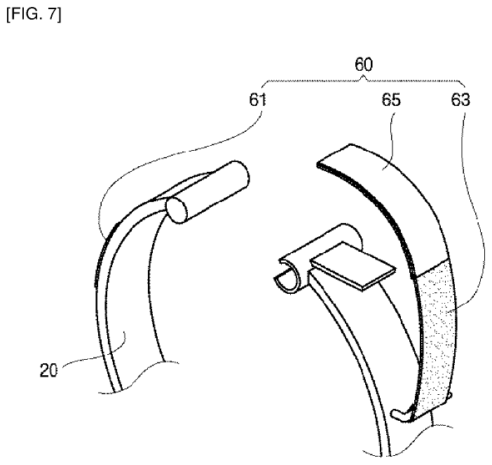

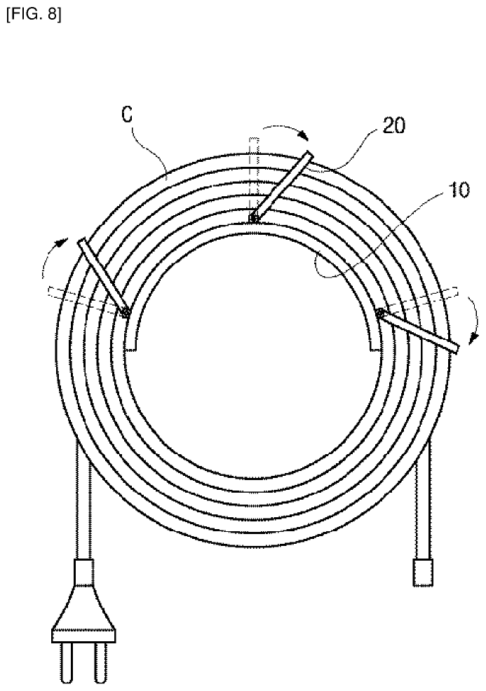

FIG. 1 is a perspective view showing a configuration of a bar-type cable organizing apparatus adaptable to a cable volume according to one embodiment of the present invention, FIG. 2 is a perspective view showing a configuration of a bar-type cable organizing apparatus adaptable to a cable volume according to another embodiment of the present invention, FIG. 3 is a perspective view showing a configuration of a bar-type cable organizing apparatus adaptable to a cable volume according to still another embodiment of the present invention, FIG. 4 is a partial perspective view showing configurations of a coupling device and a holding part of the bar-type cable organizing apparatus adaptable to the cable volume according to the present invention, FIG. 5 is a partial perspective view showing the configuration of the holding part of the bar-type cable organizing apparatus adaptable to the cable volume according to the present invention, FIG. 6 is a partial perspective view showing a configuration of a guide plate of the bar-type cable organizing apparatus adaptable to the cable volume according to the present invention, and FIG. 7 is a partial perspective view showing a configuration of an auxiliary locking device of the bar-type cable organizing apparatus adaptable to the cable volume according to the present invention.

Referring to FIGS. 1 to 7, according to the present invention, a bar-type cable organizing apparatus 1 adaptable to a cable volume may include a main body 10 and a holding part 20.

First, the main body 10 may be formed of a flexible material in a rectangular band shape, and may have an elastic restoring force so as to be freely bent and unbent, or have a metal bar (not shown) formed of a soft material and inserted into the main body 10 so that the main body 10 may maintain a shape corresponding to a deformed shape of the metal bar. In this case, the main body 10 may basically have a straight line shape, in which opposite ends and a central portion of the main body 10 where the holding part is disposed may have a relatively wide width, and a part between the central portion and the opposite ends may have a straight line shape or a streamlined shape or may be variously formed with an icon, a character design, or the like. The above configuration is provided to ensure winding stability of a cable when the cable is wound, to reduce a cost by minimizing materials, to deliver a message, to secure a brand image, and the like.

In addition, the main body 10 is preferably formed of a material having an elastic restoring force, such as PVC, plastic, ceramic, rubber, bamboo, a metal, and a non-metal, may be subject to an insulating operation such as sheathing or coating when formed of a conductive metal, and may be manufactured to have an elastic restoring force added by using a joint, a hinge, a spring, and the like, such as a watch band, even when formed of a material that is not the material having the elastic restoring force.

Further, the main body 10 may be formed integrally with the holding part 20 as shown in FIG. 1, or may be provided on a top surface thereof with a coupling device 30 coupled with the holding part 20 to allow the holding part 20 to rotate as shown in FIG. 2. The coupling device 30 is preferably configured as a press-fit hole 31 as shown in FIG. 4(a) or a hinge sill 33 as shown in FIG. 4(b), and any structure coupled with the holding part 20 to allow the holding part 20 to rotate may be applied.

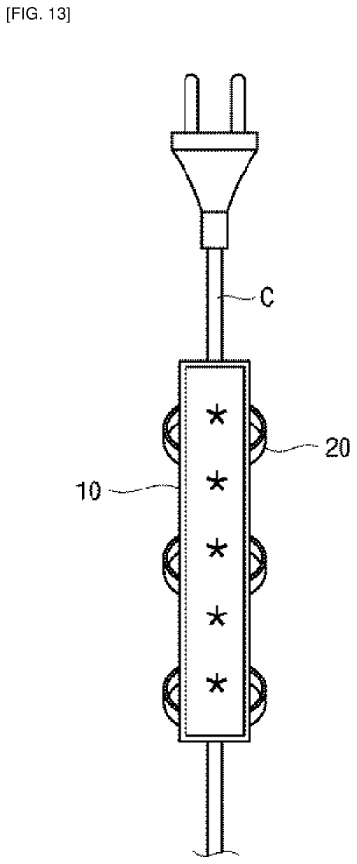

In addition, the main body 10 is preferably provided on a bottom surface thereof with an adhesive device (not shown) that is attachable to a wall surface, or a sticker S (see FIG. 13) on which an advertisement, a decoration, or an identification code is printed is preferably attached to the bottom surface of the main body 10. Further, the main body 10 is preferably mixed with a thermochromic pigment so as to be discolored and recognized by a user when the cable is overheated due to an overload or an electrical short.

Moreover, as shown in FIG. 3, the main body 10 may include: a fixed part A having a hollow shape to allow a length of the main body 10 to be varied; and a variable part B configured to slide in a longitudinal direction while being accommodated in the fixed part A to allow the length of the main body 10 to be varied. In this case, the variable part B may be provided at an end thereof with a stopper (not shown), and the fixed part A may be provided with a stepped sill (not shown), so that separation may be prevented.

Subsequently, the holding part 20 may be formed of an elastic material to expand and contract according to a volume of various cables inserted thereto; the holding part 20 may be manufactured in a circular or elliptical ring shape, a rectangular ring shape, a double ring shape, or a ring shape to which a character or icon design such as various animals or flowers is added with an open upper portion so as to facilitate entry and exit, and winding and unwinding of the cable; and the holding part 20 may be formed integrally with the main body 10, or provided at a lower end thereof with a hinge shaft 21 coupled to the coupling device 30 of the main body 10 so as to rotate as shown in FIG. 4. In this case, the holding part 20 may be formed of a material having an elastic restoring force, such as PVC, plastic, ceramic, rubber, bamboo, a metal, and a non-metal, may be subject to an insulating operation such as sheathing or coating when formed of a conductive metal, may be manufactured to have an elastic restoring force added by using a joint, a hinge, a spring, and the like even when formed of a material that is not the material having the elastic restoring force, and may be bound in a twisted shape by inserting a soft metal into the holding part 20 as the elastic material. In addition, one holding part 20 may be formed in the longitudinal direction on the top surface of the main body 10, or a plurality of holding parts 20 may be spaced apart from each other as shown in FIGS. 1 and 2 in the longitudinal direction on the top surface of the main body 10, so that the holding part 20 may accommodate the cable.

In addition, the holding part 20 may be press-coupled to the coupling device 30 of the main body 10 or installed to have an angle fixed in multiple stages so as to maintain a changed state when the holding part 20 is pressed and bent in order to fix the cable. In other words, the holding part 20 may be manufactured to have a thickness that is wide at a lower end and gradually narrows toward un upper end, and the hinge shaft 21 may have a polygonal shape or may be provided with a rotation braking device such as a gear shape or a concavo-convex portion so as to rotate by a pressing operation and maintain a current position when a pressure is released. When winding (unwinding) a part of a cable, when winding (unwinding) a cable with a small amount of the cable left, or when winding a cable having a small volume (having a thin thickness or a short length) compared to an inner diameter of the holding part even though the entire cable is wound, the wound cable may be loosened. In this case, the cable may be prevented from being loosened by simply pushing and pressing the wound cable by laterally laying the holding part 20.

Further, locking devices 40 may be provided on opposite sides of an upper end of the holding part 20, respectively, so that open portions of the holding part 20 may be coupled to each other to prevent the cable from being separated. The locking device 40 may be formed in a hook type as shown in FIG. 5, or a buckle type, a button type, a locking type, a button type, and the like may be variously applied to the locking device 40.

Meanwhile, FIG. 5 shows one embodiment of the locking device 40. A protrusion 41 may protrude from one end of the locking device 40, a ring 43 that is partially cut may be formed at an opposite end of the locking device 40 to accommodate the protrusion 41, and a locking release bar 45 may be formed at an upper end of the ring 43, so that when a pressure is applied to the locking release bar 45, the ring 43 may be spread to discharge the protrusion 41.

In addition, the holding part 20 may have one surface of the upper end, which is slightly opened. In this case, without a separate locking device 40, the cable may be inserted into an inner diameter portion of the holding part 20 so as to be trapped when the cable is pressed against an open section by applying a predetermined force or more, and the cable may be drawn out of the holding part when the inserted and trapped cable is grabbed and pulled out of the inner diameter portion of the holding part 20 by applying a predetermined force or more. Instead of the locking device 40, as shown in FIG. 6, a guide plate 50 may extend horizontally from opposite ends of the upper end or the holding part 20 to prevent the cable from being separated and to guide the insertion of the cable.

Further, since the guide plate 50 is thinner than the upper end of the holding part 20, the cable may be inserted into an inner diameter portion of the holding part so as to be trapped as the guide plate 50 is bent downward when the cable is pressed against an open section by applying a predetermined force or more, and the cable may be drawn out of the holding part 20 as the guide plate 50 is bent upward when the inserted and trapped cable is grabbed and pulled out of the inner diameter portion of the holding part by applying a predetermined force or more.

In addition, the holding part 20 may be provided with an auxiliary locking device 60 to prevent the cable from being separated as shown in FIG. 7. A female Velcro tape 61 may be attached to one end of the holding part 20, and a male Velcro tape 65 may be connected and installed to an opposite end of the holding part 20 through an elastic material such as a rubber band 63. When the locking device of the holding part may not be locked because a cable having a volume that exceeds the inner diameter of the holding part 20 is inserted into the holding part 20 and wound, the male Velcro tape 65 may be pulled and attached to the female Velcro tape 61, so that any cable having a volume that exceeds a maximum volume of the holding part 20 may be adaptively and smoothly bound according to the volume thereof. In this case, only a rubber band may be used as the auxiliary locking device 60, a magnet or the like may be used instead of a Velcro tape, and a buckle type, a button type, and the like may also be applied.

Further, similar to the main body 10, the holding part 20 may be mixed with a thermochromic pigment so as to be discolored and recognized by a user when the cable is overheated due to an overload or an electrical short.

Hereinafter, an operation of the bar-type cable organizing apparatus adaptable to the cable volume according to the present invention will be described in detail with reference to the accompanying drawings.

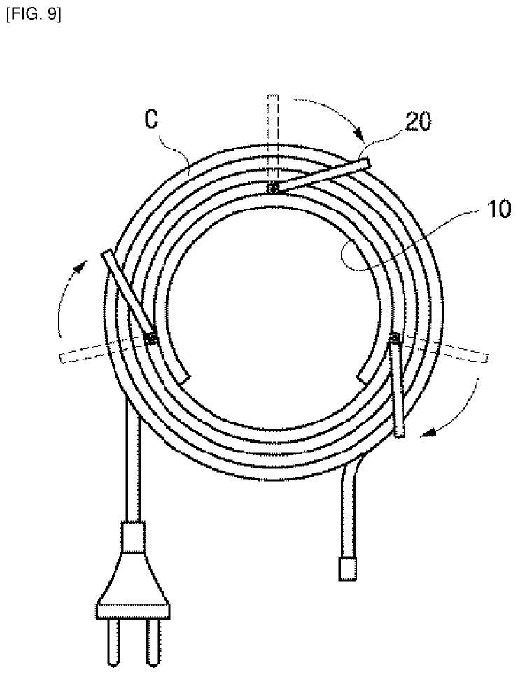

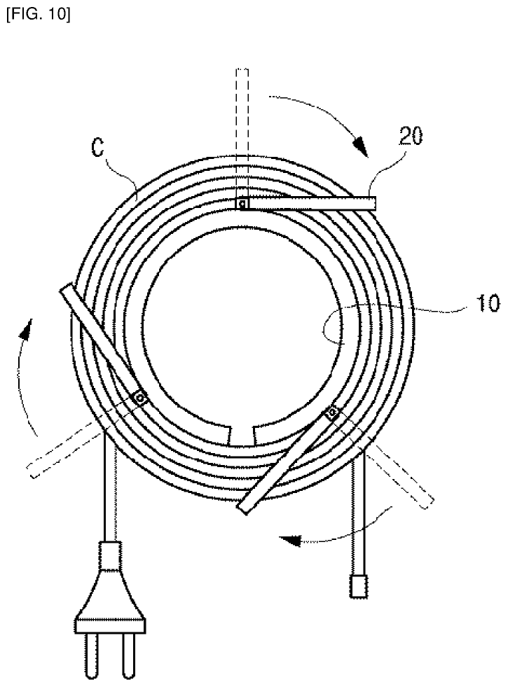

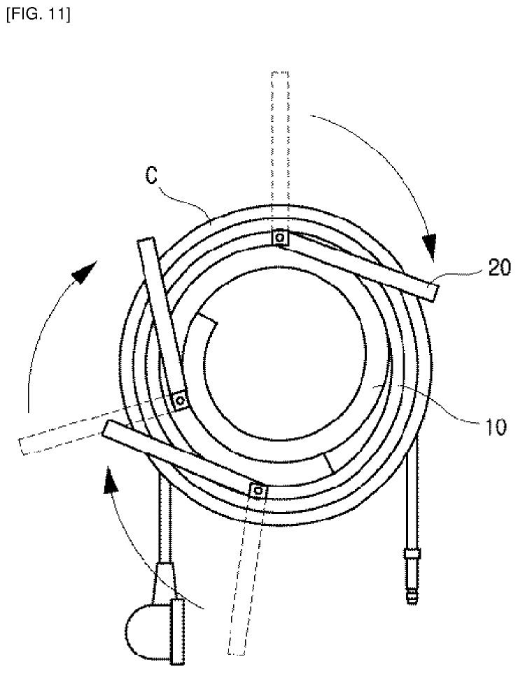

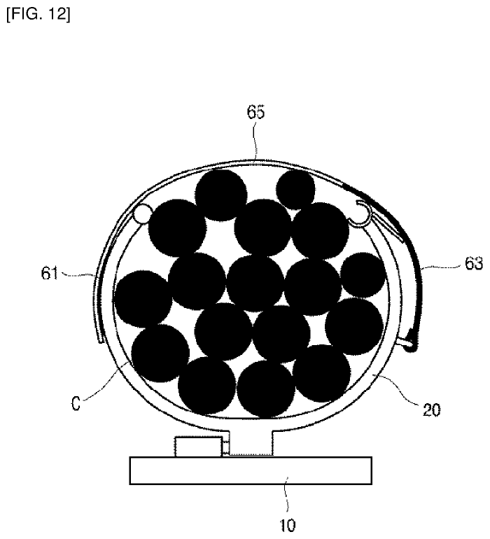

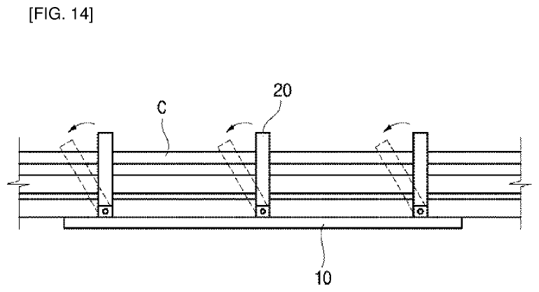

FIGS. 8 to 11 are operation views for describing states in which a cable is organized by using the bar-type cable organizing apparatus adaptable to the cable volume according to the present invention, FIG. 12 is an operation view for describing a state in which a cable is organized by using the auxiliary locking device of the bar-type cable organizing apparatus adaptable to the cable volume according to the present invention, FIG. 13 is an operation diagram for describing a state in which an advertisement of the bar-type cable organizing apparatus adaptable to the cable volume according to the present invention is exposed, and FIG. 14 is an operation diagram for describing a state in which the bar-type cable organizing apparatus adaptable to the cable volume according to the present invention is used as a cable tie.

As shown in FIGS. 8 to 11, according to the present invention, the bar-type cable organizing apparatus 1 adaptable to the cable volume may be configured such that the holding part 20 is basically in a slightly open state to facilitate the entry and exit of a cable C, and the main body 10 is in a straight line state.

In this state, as the cable C to be organized starts to be wound, a magnitude of a winding force may be adjusted according to a thickness or a length of the cable C to adjust a circumference for winding the cable by bending the main body 10, and the cable C may be wound by a required length, or the cable C may be completely rolled around and wound into the holding part 20 by an entire length.

Accordingly, the cable may be wound in a large circular shape according to the magnitude of the applied force, wound in a circular shape with an appropriate size, wound with a complete circumference obtained by fixing the opposite ends of the main body 10, and wound in a smaller size by a vortex shape of the main body 10, that is, a shape in which one end is inserted into an inner side of an opposite end. In this case, when the main body 10 has a vortex shape, the main body 10 located on an outer side may be inserted and rolled into the holding part 20 located in a rolled-in portion of the main body 10.

In addition, when the cable C is wound, the cable C may not be easily reduced while a pressure of the cable C applied toward the main body 10 exists. This is because the main body 10 has an elastic recovery force, and the cable C also has a predetermined elastic recovery force. Further, cable sections that are already wound may not be easily unwound or loosened. This is because the holding part 20 has an elastic recovery force, and thus has a force to return in a circle center direction while being pushed in an opposite direction of the circle center direction by the insertion of the cable C.

Therefore, a bending degree of the main body 10 may be increased or decreased only when a predetermined force or more is applied, and a circumferential frame of the cable may be formed due to an elastic force and a tension of the cable once the cable C is wound by 1 or 2 turns, so that a force for pressing the main body 10 may be reduced, and thus a size of the main body 10 that is once formed may be maintained.

In addition, when the winding is completed and a final portion of the cable C is fitted into the holding part 20, the entire cable may be prevented from being unwound or loosened due to a pressure of the holding part 20 in the longitudinal direction.

Subsequently, when the locking device 40 of the holding part 20 is locked, the wound cable C may be fixed while being trapped in the holding part 20.

In a case where the inserted and wound cable has a volume that is less than the inner diameter of the holding part 20 (has an insufficient volume), when a predetermined force or more is applied to the holding part 20 to lay the holding part 20, the cable C may be prevented from being loosened or unwound. In this case, the cable C may be fixed even when the locking device 40 is not provided or the locking device 40 is not fastened.

On the contrary, as shown in FIG. 12, in a case where the inserted and wound cable has a volume that exceeds the inner diameter of the holding part 20 (has an excessive volume), which makes it difficult to fasten the locking device 40, when the final portion of the cable C is fitted into the open portion of the holding part 20 after the winding is completed, the entire cable may be prevented from being unwound or loosened due to the pressure of the holding part 20 in the longitudinal direction, and the cable C may be bound by using the auxiliary locking device 60 in order to prevent the cable C from being separated to a lateral side.

In addition, when the winding of the cable C is completed, the bar-type cable organizing apparatus 1 adaptable to the cable volume according to the present invention may be carried or stored, or electrical and electronic products may be used, and when it is necessary to unwind the cable C, the holding part 20 may be erected, and the cable may be drawn out of the holding part 20 by a required length. In this case, the cable C may be unwound by unlocking the locking device 40, the locking device 40 may be locked again when the drawing of the cable C is completed, and the holding part 20 may be pressed and laid to fix the cable C.

Meanwhile, the entire cable C wound around the bar-type cable organizing apparatus 1 adaptable to the cable volume according to the present invention may be unwound, and the bar-type cable organizing apparatus 1 adaptable to the cable volume may be attached to the cable C of the electrical and electronic products so as to be stored as shown in FIG. 13 to prevent loss and achieve subsequent usability when the bar-type cable organizing apparatus 1 is unused and carried. In other words, the holding part 20 may be fitted to the cable C, the locking device 40 may be locked, and the holding part 20 may be fixedly laid.

In addition, an advertising effect may be obtained by rotating the main body 10 such that the bottom surface of the main body 10 is exposed to an outside, and prints or stickers may be attached to the bottom surface of the main body 10, which may be used for various purposes. When an interior image or an artistic image is printed on the bottom surface, an electronic product name is written to identify the electronic product name of the cable, a campaign phrase or image such as energy saving is printed, or a sticker is attached, an interior wrapping effect may be obtained, and when used as a promotional material, an advertising phrase or image may be printed or attached.

Further, as shown in FIG. 14, the bar-type cable organizing apparatus 1 adaptable to the cable volume according to the present invention may also be used as a cable tie for binding a single cable or integrally binding a plurality of cables. In this case, the advertising effect may be obtained by exposing a rear surface of the main body 10 to a front side.

Various modifications can be made to the present invention, various embodiments of the present invention can be provided, and only specific embodiments thereof have been described in the detailed description of the invention. However, it should be understood that the present invention is not limited to the specific embodiments described in the detailed description, and the present invention shall be construed as encompassing all modifications, equivalents, and substitutes within the spirit and scope of the present invention as defined by the appended claims.

Description of Reference Numerals

| | | | |
|---|---|---|---|
| 10: | Main body | 20: | Holding part |
| 30: | Coupling device | 40: | Locking device |
| 50: | Guide plate | 60: | Auxiliary locking device |
| C: | Cable | | |

1. A bar-type cable organizing apparatus adaptable to a cable volume, the bar-type cable organizing apparatus comprising:
a main body formed of a flexible material in a rectangular band shape; and
one or a plurality of holding parts spaced apart from each other in a longitudinal direction on a top surface of the main body to accommodate a cable, and formed of an elastic material in a cylindrical ring shape with an incision at an upper end thereof,
wherein the main body is pressed so as to be deformed into a curved shape, a circular shape, or a vortex shape, and the cable is wound and stored in the holding part located on an outer side of the main body.

2. The bar-type cable organizing apparatus of claim 1, wherein the main body has an elastic restoring force.

3. The bar-type cable organizing apparatus of claim 1, wherein a metal bar formed of a soft material is inserted into the main body so that the main body maintains a shape corresponding to a deformed shape of the metal bar.

4. The bar-type cable organizing apparatus of claim 1, wherein the main body is provided on the top surface thereof with a coupling device coupled with the holding part to allow the holding part to rotate.

5. The bar-type cable organizing apparatus of claim 1, wherein the main body is provided on a bottom surface thereof with an adhesive device that is attachable to a wall surface, or a sticker on which an advertisement, a decoration, or an identification code is printed is attached to the bottom surface of the main body.

6. The bar-type cable organizing apparatus of claim 4, wherein the coupling device includes a hinge sill or a press-fit hole.

7. The bar-type cable organizing apparatus of claim 1, wherein the main body includes:
a fixed part having a hollow shape; and
a variable part configured to slide in the longitudinal direction while being accommodated in the fixed part to allow a length of the main body to be varied.

8. The bar-type cable organizing apparatus of claim 6, wherein the holding part is provided at a lower end thereof with a hinge shaft coupled to the coupling device of the main body.

9. The bar-type cable organizing apparatus of claim 6, wherein the holding part is press-coupled to the coupling device of the main body or installed to have an angle fixed in multiple stages so as to maintain a changed state when the holding part is pressed to change the angle in order to fix the cable.

10. The bar-type cable organizing apparatus of claim 1, wherein locking devices coupled to each other to prevent the cable from being separated are provided on opposite sides of an upper end of the holding part, respectively.

11. The bar-type cable organizing apparatus of claim 1, wherein a guide plate extends horizontally from opposite ends of an upper end of the holding part to prevent the cable from being separated and to guide insertion of the cable.

12. The bar-type cable organizing apparatus of claim 1, wherein the holding part includes an auxiliary locking device to prevent the cable from being separated.

13. The bar-type cable organizing apparatus of claim 1, wherein the main body or the holding part is mixed with a thermochromic pigment so as to be discolored and recognized by a user when the cable is overheated due to an overload or an electrical short.
